(19) United States
(12) Patent Application Publication
(10) Pub. No.: US 2016/0162069 A1
(43) Pub. Date: Jun. 9, 2016

(54) TOUCH SCREEN AND MANUFACTURING METHOD THEREOF, AS WELL AS DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Zhi Du, Beijing (CN); Ming Hu, Beijing (CN)

(21) Appl. No.: 14/572,743

(22) Filed: Dec. 16, 2014

(30) Foreign Application Priority Data
Dec. 9, 2014 (CN) 201410744239.X

(51) Int. Cl. G06F 3/044

(52) U.S. Cl. CPC G06F 3/044; G06F 2203/04103

(57) ABSTRACT

This disclosure provides a touch screen and a manufacturing method thereof, as well as a display device. The touch screen comprises a first substrate and a second substrate arranged above the first substrate, the touch screen further comprises a first electrode layer directly formed on the second substrate and a second electrode layer arranged above the first electrode layer, wherein the first electrode layer and the second electrode layer are electrically isolated. The transmittance of the touch screen is significantly increased, and the thickness thereof is prominently reduced, while the touch performance is not reduced.

### RELATED APPLICATIONS

The present application claims the benefit of Chinese Patent Application No. 201410744239.X, filed Dec. 9, 2014, the entire disclosure of which is incorporated herein by reference.

### FIELD OF THE INVENTION

This disclosure relates to the field of display technology, more particularly to a touch screen and a manufacturing method thereof, as well as a display device.

### BACKGROUND OF THE INVENTION

The touch screen has been more and more widely used in consumer electronic products, it is exactly in the process of developing from a small size screen such as the touch screen of a mobile phone to even larger size screen. In various types of touch screens, the capacitive touch screen has become one of the current mainstream touch screens by right of its advantages of relatively high touch control sensitivity and being capable of realizing multi-touch. The capacitive touch screen mostly adopts the projection-type multi-touch capacitive technology. The structure of a projection-type capacitive touch screen can protect the conductors and the sensors and can prevent the external environmental factors from influencing the touch screen more effectively.

The current mainstream capacitive touch screen has the structures of OGS, G+G, G+F, G+F+F, in-cell, on-cell and so on. Due to the overall consideration of the cost factor and the touch control performance, the G+F+F type touch screen has a relatively high market share. However, due to the presence of double layer film and double layer optical clear adhesive, the product has a relatively bad performance in terms of thickness and transmittance.

### SUMMARY OF THE INVENTION

The object of this disclosure is to provide a touch screen and a manufacturing method thereof, as well as a display device to solve part or all of the above defects.

According to an aspect of this disclosure, a touch screen is provided, comprising a first substrate and a second substrate arranged above the first substrate, the touch screen further comprising a first electrode layer directly formed on the second substrate and a second electrode layer to arranged above the first electrode layer, wherein the first electrode layer and the second electrode layer are electrically isolated.

Compared with the conventional G-F-F touch screen, the present touch screen reduces a layer of conductive film. Particularly considering that the optical clear adhesive is usually used as jointing technology, the touch screen further reduces a layer of optical clear adhesive. Consequently, the transmittance of the touch screen is greatly increased, and the thickness thereof is significantly reduced, while the touch performance is not reduced.

In an embodiment, the touch screen may further comprise a cover plate arranged above the second electrode layer.

In an embodiment, the cover plate may further comprise a light shielding layer, the light shielding layer being located on a surface of the cover plate facing the second electrode layer. The light shielding layer can be used for shielding the wires at the border.

In an embodiment, the first electrode layer comprises one or more first electrodes and a first wire pattern connecting the one or more first electrodes. Similarly, the second electrode layer comprises one or more second electrodes and a second wire pattern connecting the one or more second electrodes.

In an embodiment, the touch screen further comprises a base substrate on which the second electrode layer is formed. Moreover, in some embodiments, the base substrate may be a polyethylene glycol terephthalate (PET) base substrate.

In an embodiment, the second wire pattern is a second wire pattern made of silver paste. This can reduce resistance of the second wire pattern.

In an embodiment, the first electrode layer may be a driving electrode layer.

In an embodiment, the second electrode layer may be a sensing electrode layer.

In an embodiment, the first substrate may be an array substrate.

In an embodiment, the second substrate may be a color filter.

According to another aspect of this disclosure, a display device is provided, which comprises any touch screen as stated above.

According to a further aspect of this disclosure, a method of manufacturing a touch screen is provide, the method comprising: arranging a second substrate above a first substrate; forming a first electrode layer on the second substrate directly; forming a second electrode layer above the first electrode layer; and electrically isolating the first electrode layer and the second electrode layer.

In an embodiment, the method further comprises: arranging a plate cover above the second electrode layer.

In an embodiment, the method further comprises: forming a light shielding layer on a surface of the cover plate facing the second electrode layer.

In an embodiment, the method further comprises: forming a second wire pattern of the second electrode layer by way of screen printing silver paste, the second wire pattern connecting one or more second electrodes of the second electrode layer.

In an embodiment, the method further comprises: forming one or more electrodes of the first electrode layer and a first wire pattern connecting the one or more first electrodes by depositing an ITO film on the second substrate and by way of a one-time photoetching.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

Now the above and other aspects of the present invention will be described in more details with reference to the drawings that show the embodiments of the present invention.

FIG. 1 illustrates a schematic view of structure of a touch screen according to this disclosure; and

FIG. 2 illustrates a flow chart of an exemplary method for manufacturing a touch screen according to this disclosure.

### DETAILED DESCRIPTION OF THE INVENTION

The following embodiments are provided as examples so that this disclosure will be thorough and complete, and will fully communicate the scope of the present invention to the skilled person in the art. This disclosure is set forth in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.”

In the following description, certain terms may be used such as “up,” “down,” “upper,” “lower,” “horizontal,” “vertical,” “left,” “right,” “over,” “on,” “above,” “near,” and the like. These terms are used, where applicable, to provide some clarity of description when dealing with relative relationships. But, these terms are not intended to imply absolute relationships, positions, and/or orientations.

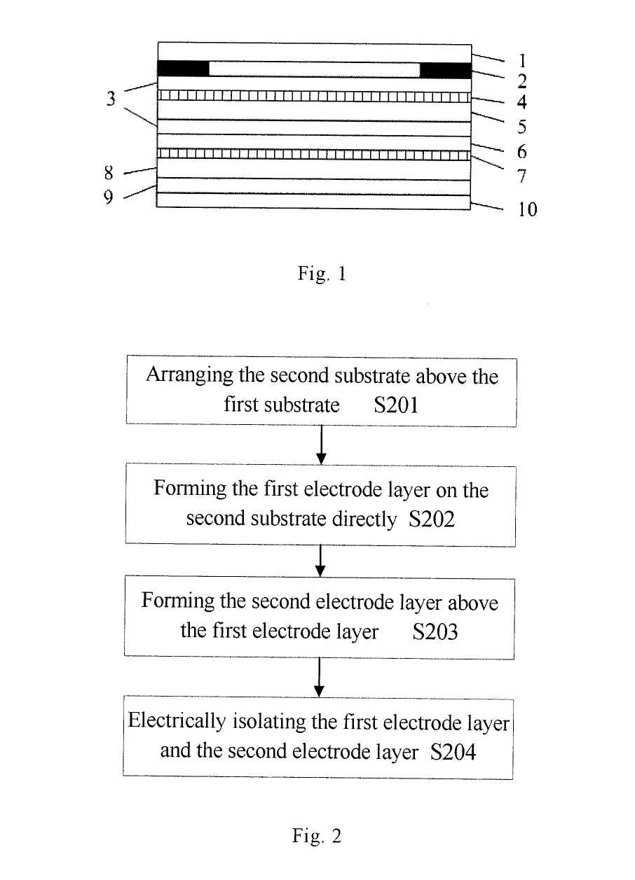

FIG. 1 illustrates a schematic view of structure of a touch screen according to this disclosure. As shown in FIG. 1, the touch screen comprises a first substrate 9 and a second substrate 8 arranged above the first substrate 9, the touch screen further comprises a first electrode layer 7 directly formed on the second substrate and a second electrode layer 4 arranged above the first electrode layer, wherein the first electrode layer 7 and the second electrode layer 4 are electrically isolated. The first substrate may be an array substrate, e.g., a liquid crystal array substrate. The second substrate may be a color filter.

In this disclosure, the first electrode layer may be a driving electrode layer, and the second electrode layer may be a sensing electrode layer.

The first electrode layer may comprise one or more first electrodes and a first wire pattern connecting the one or more first electrodes. Similarly, the second electrode layer may comprise one or more second electrodes and a second wire pattern connecting the one or more second electrodes.

The touch screen may comprise a base substrate 5 on which the second electrode layer is formed. The base substrate 5 for example may be a polyethylene glycol terephthalate (PET) base substrate. This for example can be formed by depositing a layer of conductive ITO film on the PET base substrate and screen printing etching paste on the ITO film. In addition, in order to reduce resistance of the second wire pattern, the second wire pattern may also be made of silver paste. Certainly, other well known technologies in the art are also contemplated.

The touch screen may further comprise a cover plate 1, which is arranged above the second electrode layer 4. The cover plate for example may be made of tempered glass or plastic. In addition, the cover plate may further comprise a light shielding layer 2 which is located on a surface of the cover plate 1 facing the second electrode layer. The light shielding layer can be used for shielding the wires at the border. The light shielding layer for example may be formed by screen printing ink on the lower surface of the cover plate 1.

The first electrode layer for example may be formed by depositing a layer of ITO film on the second substrate and by way of a one-time photoetching. This can simplify the manufacturing process and improve yield. The second substrate used herein for example can be processed using the following steps: depositing an ITO film on an upper surface (e.g. the surface facing the second electrode layer) of the glass substrate through magnetron sputtering, and forming the first electrode layer through photoetching, then forming R, G, B, OC, ITO, PS film layers at its back side.

In addition, the touch screen may further comprise an upper polarizer 6 and a lower polarizer 10, the upper polarizer is arranged above the first electrode layer, the lower polarizer is arranged under the first substrate 9, as shown in FIG. 1.

The second electrode layer (e.g., it may also be a PET base substrate if exists) and the second substrate (which is specifically the first electrode layer on the second substrate, or the upper polarizer if exists) as well as the cover plate and the second electrode layer (e.g., it may also be a PET base substrate if exists) can joint with each other for example through optical clear adhesive. Compared with the conventional G-F-F touch screen, the touch screen of this disclosure reduces a layer of conductive film and a layer of optical clear adhesive, thereby reducing the thickness of the product effectively, and improving the transmittance of the product, while the touch performance is not changed. In addition, this first electrode layer is formed on the second substrate, and the cutting process is performed simultaneously with the cutting of the second substrate, thereby saving a cutting process.

FIG. 2 illustrates a flow chart of an exemplary method for manufacturing a touch screen according to this disclosure. At step S201, the second substrate is arranged above the first substrate. At step S202, the first electrode layer is directly formed on the second substrate. The first electrode layer comprises one or more first electrodes and a first wire pattern connecting the one or more first electrodes. The first electrode layer may be a driving electrode layer. The one or more first electrodes as well as the first wire pattern are formed for example by depositing a layer of ITO film on the second substrate and by way of a one-time photoetching. Certainly, other well known technologies in the art are also contemplated.

At step S203, the second electrode layer is formed above the first electrode layer. The second electrode layer may be a sensing electrode layer. The second electrode layer comprises one or more second electrodes as well as a second wire pattern connecting the one or more second electrodes. The second electrode layer may also be formed on the base substrate. The base substrate may be a polyethylene glycol terephthalate base substrate. This for example can be formed by depositing a layer of conductive ITO film on the PET base substrate and screen printing etching paste on the ITO film. In order to reduce resistance of the second wire pattern, the second wire pattern may also be formed by way of screen printing silver paste.

At step S204, the first electrode layer and the second electrode layer are electrically isolated. This can be realized by means of the insulativity of the above mentioned base substrate or the optical clear adhesive. Certainly, other electrical isolation manners are also contemplated.

In addition, the method may further comprise the step of: arranging the cover plate above the second electrode layer. As described above, the method may further comprise the step of: forming the light shielding layer on a surface of the cover plate facing the second electrode layer for shielding the wires at the border.

Similarly, a display device is disclosed herein, the display device may comprise a touch screen stated above.

In view of many possible embodiments into which the principle of the disclosed invention can be applied, it should be realized that the illustrated embodiments are only preferred examples of the present invention, and should not be deemed as limitations to the scope of the present invention. On the contrary, the scope of the present invention should be defined by the following claims. We therefore claim all that fall within the scope of these claims and their equivalents as our invention.

1. A touch screen comprising a first substrate and a second substrate arranged above the first substrate, the touch screen further comprising a first electrode layer directly formed on the second substrate and a second electrode layer arranged above the first electrode layer, wherein the first electrode layer and the second electrode layer are electrically isolated; wherein the touch screen further comprises an upper polarizer arranged between the first electrode layer and the second electrode layer.

2. The touch screen according to claim 1, further comprising a cover plate arranged above the second electrode layer.

3. The touch screen according to claim 2, wherein the cover plate further comprises a light shielding layer, the light shielding layer being located on a surface of the cover plate facing the second electrode layer.

4. The touch screen according to claim 1, wherein the first electrode layer comprises one or more first electrodes and a first wire pattern connecting the one or more first electrodes.

5. The touch screen according to claim 1, wherein the second electrode layer comprises one or more second electrodes and a second wire pattern connecting the one or more second electrodes.

6. The touch screen according to claim 1, further comprising a base substrate on which the second electrode layer is formed.

7. The touch screen according to claim 5, wherein the second wire pattern is a second wire pattern made of silver paste.

8. The touch screen according to claim 1, wherein the first electrode layer is a driving electrode layer.

9. The touch screen according to claim 1, wherein the second electrode layer is a sensing electrode layer.

10. The touch screen according to claim 1, wherein the first substrate is an array substrate.

11. The touch screen according to claim 1, wherein the second substrate is a color filter.

12. A display device comprising a touch screen as claimed in claim 1.

13. A method of manufacturing a touch screen, the method comprising:
arranging a second substrate above a first substrate;
forming a first electrode layer on the second substrate directly;
forming a second electrode layer above the first electrode layer;
electrically isolating the first electrode layer and the second electrode layer; and
arranging an upper polarizer between the first electrode layer and the second electrode layer.

14. The method according to claim 13, further comprising: arranging a cover plate above the second electrode layer.

15. The method according to claim 14, further comprising: forming a light shielding layer on a surface of the cover plate facing the second electrode layer.

16. The method according to claim 13, further comprising: forming a second wire pattern of the second electrode layer by way of screen printing silver paste, the second wire pattern connecting one or more second electrodes of the second electrode layer.

17. The method according to claim 13, further comprising: forming one or more electrodes of the first electrode layer and a first wire pattern connecting the one or more first electrodes by depositing an ITO film on the second substrate and by way of a one-time photoetching.
